(19) United States
(12) Patent Application Publication
(10) Pub. No.: US 2007/0258461 A1
(43) Pub. Date: Nov. 8, 2007

(54) System and method for controlling bandwidth at a wireless endpoint

(76) Inventors: Amit Phadnis, Bangalore (IN); Naresh Sunkara, Bangalore (IN); Aseem Sethi, Bangalore (IN)

Correspondence Address: FAY KAPLUN & MARCIN, LLP, 15O BROADWAY, SUITE 702, NEW YORK, NY, 10038, US

(21) Appl. No.: 11/416,760

(22) Filed: May 3, 2006

(51) Int. Cl. H04L 12/56

(52) U.S. Cl. 370/395.21

(57) ABSTRACT

Described is a system and method for controlling bandwidth at a wireless endpoint. The method comprises receiving a bandwidth request from a device and placing the device in a bundle which includes a plurality of radios to communicate with the device. A packet addressed to the device is received and transmitted to the device via the plurality of radios.

### FIELD OF INVENTION

The present invention relates generally to systems and methods for bandwidth control at wireless endpoints.

### BACKGROUND INFORMATION

Today, a maximum bandwidth available to a wireless end point (e.g., a mobile unit (“MU”)) under an IEEE 802.11 standard is 54 Mbps. That is, an 802.11a/g radio utilized by an access point (“AP”) communicating with the MU may only successfully transmit and receive data packets up to this limit. However, despite the bandwidth limitation of the AP, some applications and MUs may require a much larger bandwidth in order to perform properly. For example, a storage area network (“SAN”) may require bandwidths in a range of 1 Gbps and 2 Gbps. Also, streaming video and HDTV may also carry a high bandwidth demand. Thus, due to bandwidth restrictions, the SAN is prevented from wireless communication, and streaming video clips may improperly execute (e.g., continually stop and start throughout). Therefore, a way of increasing the bandwidth available to wireless end points is currently desired.

### SUMMARY OF THE INVENTION

The present invention relates to a system and method for controlling bandwidth at a wireless endpoint. The method comprises receiving a bandwidth request from a device and placing the device in a bundle which includes a plurality of radios to communicate with the device. A packet addressed to the device is received and transmitted to the device via the plurality of radios.

### BRIEF DESCRIPTION OF THE DRAWINGS

FIG. 1 is an exemplary embodiment of a system on which the present invention may be implemented.

FIG. 2 is a second exemplary embodiment of a system on which the present invention may be implemented.

FIG. 3 is an exemplary embodiment of a data frame according to the present invention.

FIG. 4 is a second exemplary embodiment of a data frame according to the present invention.

FIG. 5 is an exemplary embodiment of a method according to the present invention.

FIG. 6 is an exemplary embodiment of a second method according to the present invention.

### DETAILED DESCRIPTION

The present invention may be further understood with reference to the following description and the appended drawings, wherein like elements are provided with the same reference numerals. The present invention provides a system and a method for controlling bandwidth at wireless endpoints. In an exemplary embodiment, a switch electrically coupled to a wireless local area network (“WLAN”) may bundle communication links to provide increased bandwidth capabilities for communicating with the endpoint. Although the present invention will be discussed with respect to creating the bundle at the switch, it will be understood by those of skill in the art that the bundle may be created elsewhere in the WLAN. For example, an endpoint having multiple radios may create the bundle to increase throughput.

Further, embodiments of the present invention may be described with respect to transmitting data packets to and from a storage area network (“SAN”). However, these embodiments may be used in any number of applications including, but not limited to, wireless transmission of streaming video and HDTV signals in a wireless environment. In addition, the present invention is described with reference to IEEE 802.11 communications. However, it should be apparent that the present invention is not limited to 802.11 systems and are applicable to any type of communication system where bandwidth is limited and can be extended in the manner described herein.

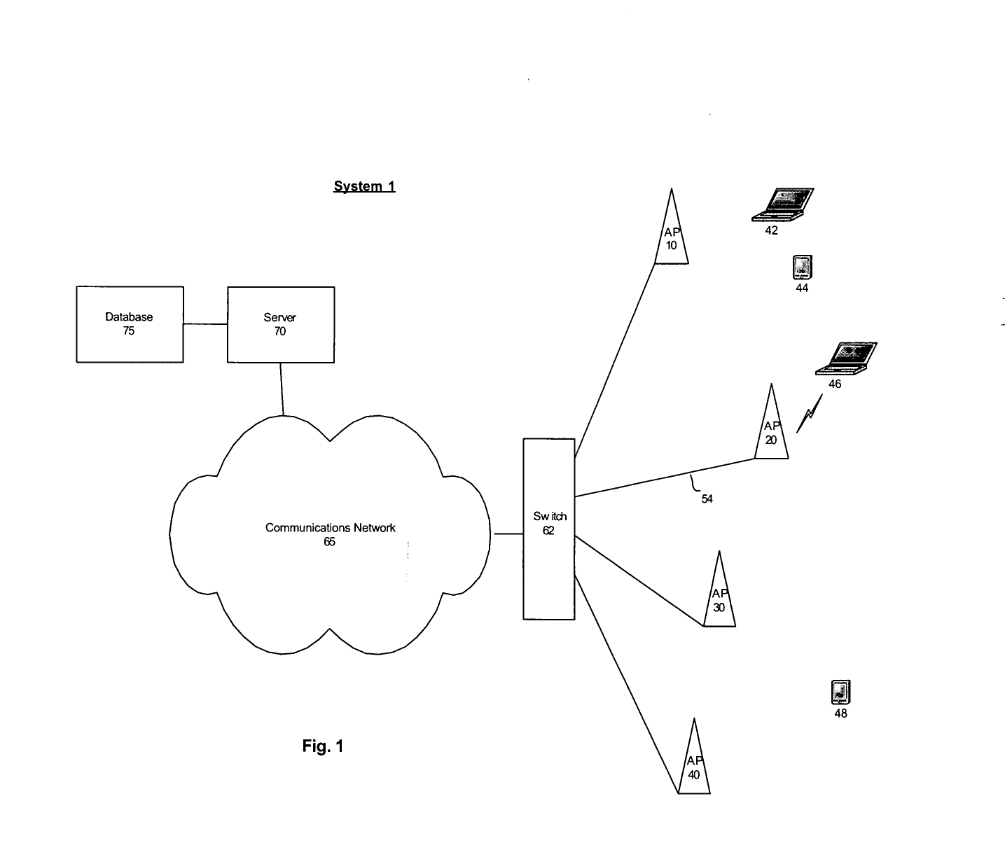

FIG. 1 of the present invention shows an exemplary system 1 including a plurality of access points/ports (“APs”) 10, 20, 30, 40 coupled to a communications network 65 via a switch 62. The APs 10-40 may be used as a medium for wireless communications between mobile units (“MUs”) 42, 44, 46, 48 and the network 65, and vice versa. As shown, the system 1 may further include a server 70 and a database 75 coupled to the network 65. The network 65 may include one or more network computing devices (e.g., a router, etc.). The server 70 may be responsible for managing the network 65 and any devices coupled thereto (e.g., the APs 10-40).

Those of skill in the art will understand that the topology of the system 1 is only exemplary. The present invention may be implemented on any network/system, regardless of topology, where the owner/operator of the network desires to control bandwidth at various endpoints within the network. For example, the switch 62 may be a wireless switch communicating wirelessly with the APs 10-40 and/or MUs 42-48. The system 1 may also include other devices such as network appliances, printers, etc. Thus, the system 1 is only used for illustrative purposes.

The MUs 42-48 serve as endpoints for wireless communications. The MUs 42-48 may be any mobile computing device or mobile communications device, such as, for example, an image/laser-based scanner, a cell phone, a laptop, a network interface card, a handheld computer, a PDA, an RFID reader, or any wireless device which utilizes one or more radios.

An MU (e.g., the MU 46) may attempt to access the network 65, and thus may attempt to associate with an AP (e.g., the AP 20) in whose coverage area it resides. Accordingly, the MU 46 engages in an association procedure and/or an authentication procedure with the AP 20. The association procedure may comprise, for example, sending a request to associate to the AP 20, which may grant or deny the request. The authentication procedure may comprise, for example, sending an encrypted username and password, which may be verified before access to the network 65 is granted. Again, those of skill in the art will understand that there are any number of manners by which an MU may associate with an AP (or other communications device). The type of association method is not relevant to the present invention, i.e., any method may be used.

Each AP may include a radio, and thus may be capable of transmitting data packets over a radio frequency (“RF”) channel. The present invention will be discussed with respect to single radio APs. However, those of skill in the art will understand that the system 1 may include APs having a plurality of radios and the present invention may be implemented on a system that includes these multi-radio APs.

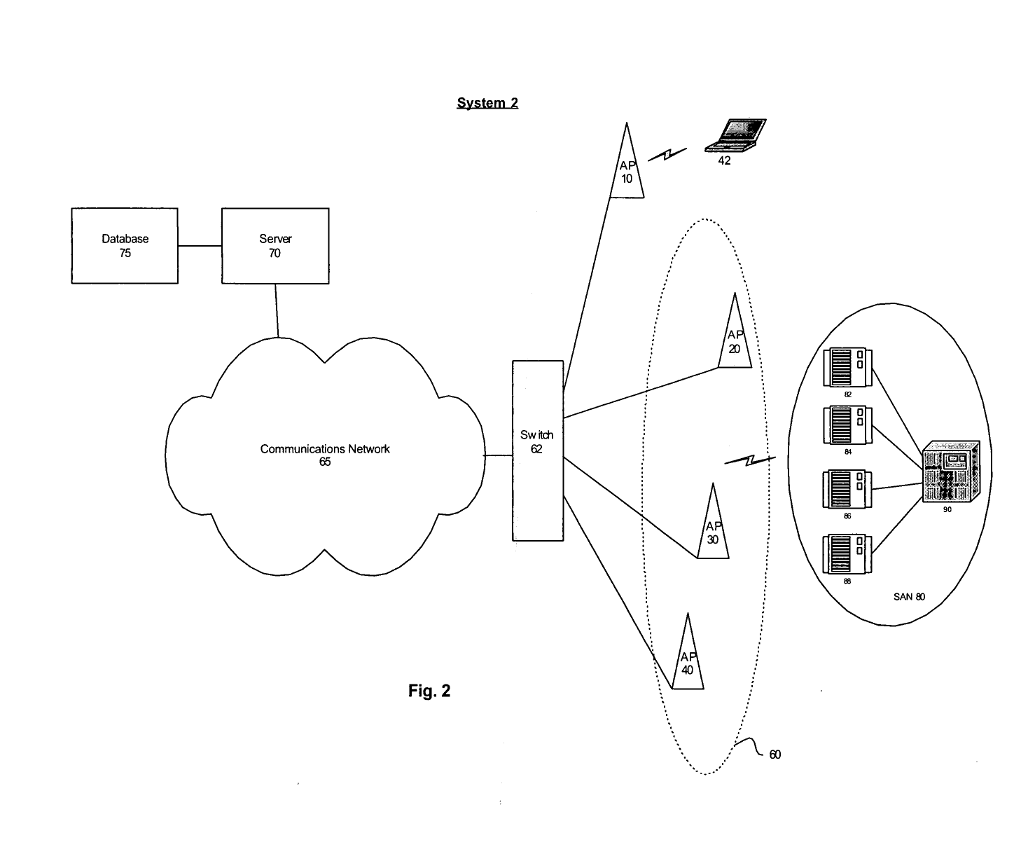

As mentioned above, some devices/applications (e.g., the SAN, HDTV signals, video streaming) may require an increased bandwidth over the normal communication bandwidth currently used in the system 1. However, the required bandwidth for these applications may exceed a maximum bandwidth for the radios utilized by the APs 10-40. For example, each of the single radio APs 10-40 may only support a maximum bandwidth of 54 Mbps. In order to satisfy high bandwidth demands, multiple radios may be joined logically to create a multilink bundle. For example, as shown in FIG. 2, the APs 20-40 may be aggregated in a multilink bundle 60 having a throughput of 162 Mbps (3×54 Mbps).

FIG. 2 shows an exemplary system 2, which is similar to the system 1 of FIG. 1, but further includes a SAN 80. The SAN 80 may comprise a plurality of storage devices 82, 84, 86, 88, which may be, for example, disks, tape drives, arrays, servers, etc. The storage devices 82-88 are electrically coupled to a backbone 90, which may communicate with the network 65. In an embodiment of the present invention, this communication may be wireless, and thus the SAN 80 may be considered to be an MU. However, although the SAN 80 may communicate with other MUs (e.g., the MU 42) through the communications network 65 (or any device in the system 2), this communication may require a substantial amount of bandwidth. Accordingly, the SAN 80 may be served by the multilink bundle 60.

The switch 62 may generate the bundle 60 using a control protocol similar to a Multilink Point-to-Point Protocol (“MLPPP”). The MLPPP is an extension of a Point-to-Point Protocol that allows multiple physical connections between two points to be combined into a logical connection, or a bundle, which provides greater bandwidth than a single connection. MLPPP also supports dynamic bandwidth allocation, and therefore links may be added to or removed from the bundle as needed. As noted above, an MU may initiate and execute creation of the bundle 60 in a similar manner as described herein with reference to the switch 62.

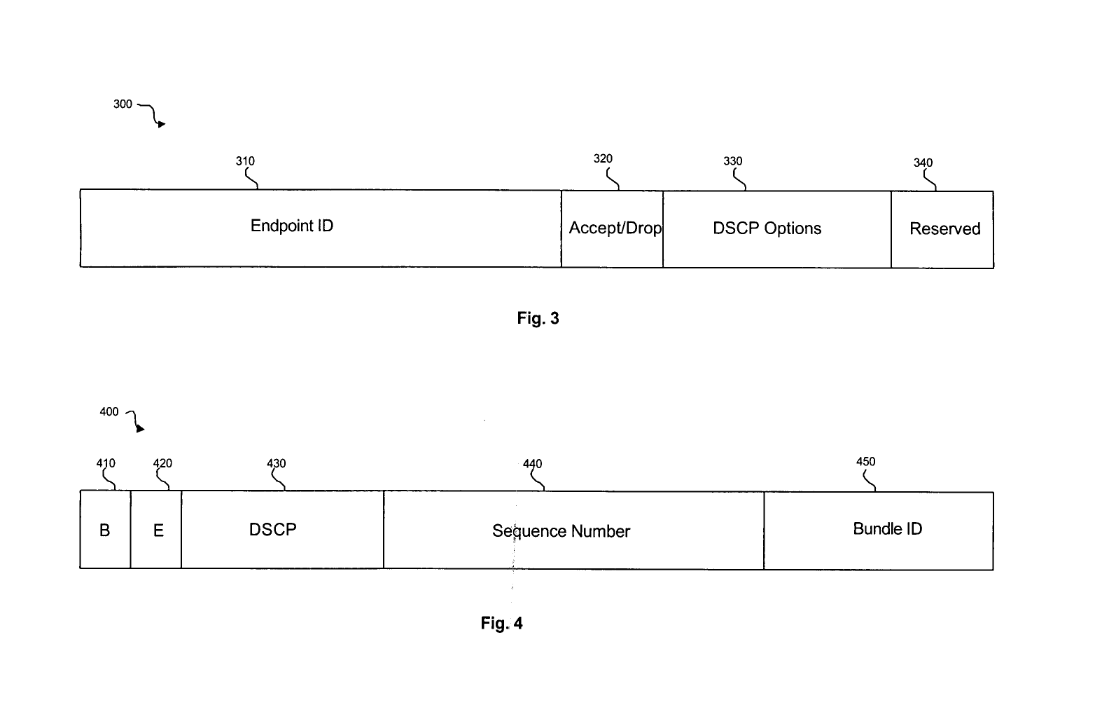

According to an embodiment of the present invention, a request to create a bundle 60 may be defined by a management frame. The management frame may include fields that identify an endpoint (e.g., an MU), specify whether a radio of the endpoint is to be added or removed from the bundle 60, specify Diff Serve code point options, etc. An exemplary embodiment of a management frame, and the fields included therein, will be described in greater detail with respect to FIG. 3.

The management frame may be sent by an MU requiring increased bandwidth, such as the SAN 80, any time after the MU has successfully associated with a corresponding AP (e.g., the SAN 80 initially associates with the AP 30). The management frame is sent to the switch 62 (i.e., the device responsible for the 802.11 communications) via the AP 30. The switch 62 may extract the information from the management frame sent by the SAN 80 and generate the bundle 60. For example, if the SAN 80 included three (3) radios, the switch 62 will understand that the bundle 60 should include three (3) radios on the AP side, thereby creating bundle 60 with one radio from each of APs 20, and 40. The switch 62 may also create an identifier (“bundle ID”) for the particular bundle. This bundle ID may be based on the identifier of the MU requesting the bundle (e.g., the MAC address of the SAN 80). The switch 62 will add the MU as a member of the bundle (e.g., a SAN 80 identifier is included with the bundle 60). The switch 62 may also add an identifier for each radio of the SAN 80 to the bundle 60. The switch 62 may acknowledge creation of the bundle 60 by sending a standard ACK frame to the SAN 80 or a frame that includes the bundle ID to the SAN 80.

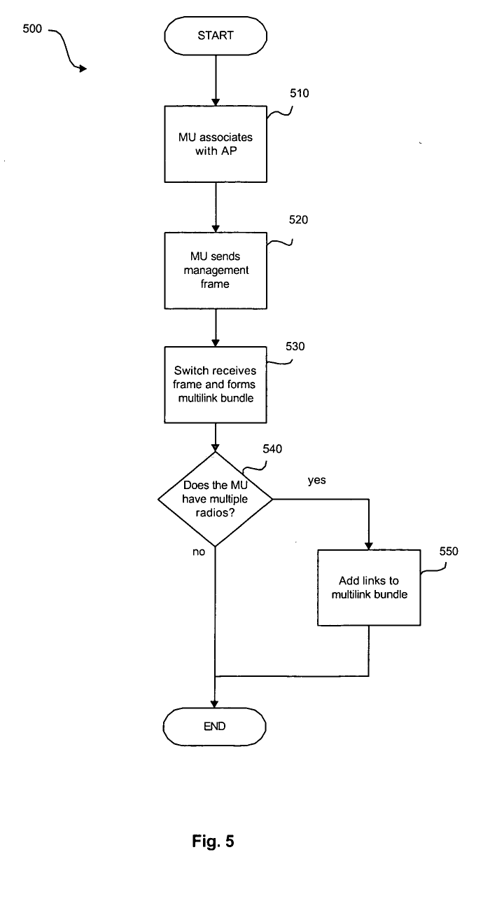

Once the bundle 60 is created, each data packet addressed to the SAN 80 and received by the switch 62 (e.g., from the communications network 65 or from the APs 10-40) may be sent on a bundle interface. Accordingly, the packet may be fragmented into a number of fragments that may be transmitted on different links. For example, a data packet sent to the SAN 80 may be fragmented into three different fragments, and each fragment may be transmitted by each of the APs 20, 30, and 40 at a single time. When received by the SAN 80, the fragments may be reordered and assembled into the data packet. In one embodiment of the present invention, the switch 62 may attach a header frame to each packet and/or fragment, as will be described in greater detail with respect to FIG. 4.

The bundle 60 may be dissected through a process similar to that by which it was created. Specifically, the SAN 80 may send a management frame requesting removal of one or more of its radios from the bundle 60. The switch 62 will take the appropriate action to disassemble the bundle 60.

FIG. 3 shows an exemplary embodiment of a management frame 300 according to the present invention. As mentioned above, an MU, which may have multiple radios, may send the management frame 300 in an attempt to create a bundle. The exemplary frame 300 may include an Endpoint ID field 310, an Accept/Drop field 320, a DSCP Options field 330, and a Reserved field 340. Those of skill in the art will understand that the management frame 300 is only exemplary and there may be other forms of the management frame that can be used to accomplish the same purposes described herein for the management frame.

The Endpoint ID field 310 may contain data which identifies the MU that desires to create the bundle. In one embodiment of the present invention, the identifying data may be a medium access control (“MAC”) address of the MU. However, any unique number that identifies the MU may be used. In a preferred embodiment, the Endpoint ID field 310 is approximately forty eight bits in length.

The Accept/Drop field 320 may be used to indicate whether the MU is requesting to add or remove one of its radios to/from the bundle. In a preferred embodiment of the present invention, this field occupies only one bit, e.g., “on” indicating an add request and “off” indicating a remove request.

The DSCP Options field 330 may be used to set a Diff Serv code point (“DSCP”) for a packet transmitted over the bundle. A DSCP is a modification of a type of service (“TOS”) byte used during, for example, voice packet transmissions. Six bits of the byte are reallocated to specify a particular per-hop behavior that is applied to a packet.

The Reserved field 340 reserves a space in the management frame for future use. The space may be utilized to control multilink behavior. In a preferred embodiment of the present invention, two bits may be reserved for this field.

As mentioned above, transmission of the management frame 300 by an MU may initiate creation of the bundle 60. Once the bundle 60 is created, packets sent to the MU may be received by the switch 62 and transmitted on the bundle interface. The switch 62 may add a header frame to the packet, and schedule the packet for transmission to the MU. Although any scheduling mechanism may be used, round robin scheduling is preferred. The round robin scheduling mechanism may be simplest, as it handles each interface as having a same priority. In one embodiment, scheduling may be controlled by the switch 62. Accordingly, the switch 62 may have a reference to a start of the bundle's membership list and a reference to a current interface. Thus, the switch may easily determine which interface on the list should be next selected.

In another embodiment of the present invention, it may be desirable to assign a priority to each bundled radio. Therefore, the packets may be scheduled to correspond to the assigned priorities. In a further embodiment, one or more radios may be reserved for future use. For example, it may be anticipated that voice packets, which consume a large amount of bandwidth, will be transmitted. Thus, it may be desirable to reserve one or more radios in the bundle and to utilize them when necessary.

FIG. 4 shows an exemplary embodiment of a bundle header 400 according to the present invention. As mentioned above, the bundle header 400 may be added to each packet that is transmitted on the bundle interface by the switch 62. The bundle header 400 may include any number of fields of varying sizes that serve any number of purposes. As shown in FIG. 4, the bundle header 400 may include a Begin fragment field 410, an End fragment field 420, a DSCP field 430, a Sequence Number field 440, and a Bundle ID field 450.

The Begin fragment field 410 may be one bit. The bit may be set to 1 on a first fragment of a packet transmitted over the bundle interface. The bit may be set to 0 for all other fragments from the same packet. Similarly, the End fragment field 420 may also be one bit and may be set to 1 on a last fragment of the packet sent over the bundle interface. The bit may be set to 0 for all other fragments. It is possible that both the Begin fragment field 410 and the End fragment field 420 may be set to 1. This situation may arise if, for example, the packet is not fragmented.

The DSCP field 430 is similar to the DSCP field 330 of the management frame 300. In one embodiment of the present invention, the bit value in the DSCP may be copied from the DSCP field 330 in the management frame used to generate the bundle 60 to each fragment transmitted on the bundle interface.

The Sequence Number field 440 may be used to preserve a sequence in which packets are transmitted over the bundle. Preserving the sequence may be of increased importance when the incoming packet is fragmented so the MU may reconstruct the fragmented packet. In a preferred embodiment of the present invention, sixteen bits may be allocated to the Sequence Number field 440.

The Bundle ID field 450 may be used to identify each bundle created on the switch. In one embodiment, a unique identifier is associated with each bundle and communicated to the MU in response to the transmission of the management frame 300. For example, the identifier may be included in a Type Length Value (“TLV”) format in a body of the acknowledgment frame sent by the switch 62 to the MU. The switch 62 may create any identifier that it chooses and the MU uses this identifier when transmitting on the bundle 60. In a preferred embodiment of the present invention, the Bundle ID field 450 may occupy eight bits.

FIG. 5 shows an exemplary method 500 according to an embodiment of the present invention. The method 500 will be described with reference to the exemplary system 2 shown in FIG. 2. However, it will be understood by those of skill in the art that the method 500, and modifications thereof, may be implemented on various network architectures.

In step 510, an MU associates with an AP (e.g., the SAN 80 associates with AP 30). The SAN 80 may perform a conventional association and/or authentication procedure, as described above. The SAN 80 may utilize a single radio to conduct the association and authentication.

In step 520, the SAN 80 transmits the management frame to the switch 62 (via the AP 30) to initiate creation of the bundle 60. The management frame may be similar to the frame 300 of FIG. 3. Accordingly, it may include a unique endpoint identifier that corresponds to the SAN 80. For example, the endpoint identifier may be the MAC address of the SAN 80. Further, the management frame 300 may request that a radio be added to a bundle or removed therefrom. For purposes of the present example, it will be assumed that the management frame 300 is requesting addition of the radio.

In step 530, the switch 62 receives the management frame 300 and generates the multilink bundle 60. The switch 62 may acknowledge receipt of the management frame 300 and creation of the multilink bundle 60. In one embodiment, acknowledgment may be effected by sending an “ACK” frame to the SAN 80 which includes the bundle ID.

In step 540 it is determined whether the SAN 80 wishes to add one or more radios to the bundle 60. If the SAN 80 is adding more radios, it may transmit further management frames that include identifiers for those radios, as well as the bundle ID. The switch 62 may add each radio to the bundle 60 (step 550). The switch 62 may retain the association identifier and the endpoint identifier that correspond to the SAN 80, and associate them with each radio that is added to the bundle 60. Thus, the bundle 60 may also be identified by the association identifier and the endpoint identifier of the SAN 80.

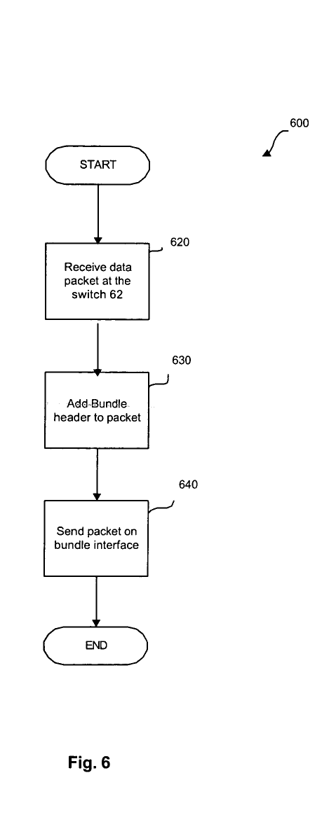

FIG. 6 shows an exemplary embodiment of a method 600, which may be performed after the bundle 60 is created. As discussed above, the bundle 60 is created by the switch 62. The switch 62 may acknowledge the creation of the bundle 60 by transmitting a frame to MUs that are members of the bundle 60. Data packets may thus be transmitted to/from the SAN 80 over the bundle interface. For example, the MU 42 may access the SAN 80 to retrieve stored data.

In step 620, the data packet (e.g., a data request from the MU 42 to the SAN 80) is received at the switch 62. In step 630, a bundle header is added to the packet, which may be fragmented by the switch 62 for transmission over the bundle interface. As discussed above, the packet may be fragmented in order to successfully effect transmission. Fragmentation may be of increased importance if the packet is particularly large in order to avoid throughput problems. The bundle header may be similar to the bundle header 400 of FIG. 4. Transmission of the packet may be sequenced according to a scheduling mechanism, such as round robin scheduling, priority queuing, first in first out (FIFO), etc. In step 640, the switch 62 transmits the packet on the bundle interface to the SAN 80. It will be understood by those of skill in the art that packets addressed to MUs that are not bundled, for example the MU 42, will be transmitted along an unbundled link.

An advantage of the present invention is that it provides wireless access to devices that need a high bandwidth (e.g., storage area networks). A further advantage is that this wireless access may be provided using existing wireless infrastructures. For example, the bundle can be created without employing any additional hardware modules.

It should be noted that the bundles that are created may be predetermined bundles or bundles that are created as needed. For example, the switch 62 may include a bundle 60 (with a bundle interface) that has a set number of AP members to correspond to desired characteristics within the system. For example, the system administrator may create bundle 60 with APs 20-40 to serve any MU that desires up to a three (3) radio bundle within a certain coverage area that corresponds to the three (3) APs 20-40. Thus, any MU that requests a two or three radio bundle within the defined coverage area may be added to the bundle 60 as needed. However, the bundle 60 with its defined characteristics will remain in place at the switch 62. This type of arrangement may work well when the MU is not truly mobile and is likely to remain in the same general location such as the SAN 80.

However, in another embodiment, there may be no pre-defined bundles, i.e., bundles will be created by the switch 62 on an as-needed basis. For example, when the MU sends a management frame requesting a bundle be created, the switch 62 may receive the request and determine the characteristics that are needed to satisfy the MU making the request, e.g., the APs that may transmit to the MU based on coverage area, the number of radios the MU desires to add to a bundle, etc. The switch 62 may then create the most appropriate bundle based on the characteristics of the MU requesting the bundle. For example, the switch 62 may determine that if the MU 42 is requesting a two radio bundle, the most appropriate bundle would include APs 10 and 20. This type of arrangement may work well when the MU is moving and the coverage areas of the APs are a greater consideration when creating bundles. Similarly, as the MU moves, the switch 62 may add or delete APs from the bundle to account for the location change of the MU.

In addition, in the above description, it was considered that the data packet that was fragmented was being sent from the switch 62 to the SAN 80. Data packets that are sent in the other direction, i.e., from the SAN 80 to the switch 62, may also be fragmented after the SAN 80 is added to the bundle 60. For example, the SAN 80 may include the functionality to fragment data packets (e.g., fragment packets and add headers indicating how they should be put back together). The fragments can then be sent by the multiple radios of the SAN 80 and received by one or more of the radios of the APs in the bundle 60 (APs 20-40). The APs may then send the fragments to the switch 62 that may include the functionality to reconstruct the fragments into the original data packet and forward it to the destination. Thus, the bundles may allow for increased bandwidth in both directions.

Furthermore, in some instances the above description included functional descriptions of manners for implementing the present invention. For example, the switch was described as receiving the management frame from the MU and the switch was described as placing the MU into the bundle. Those of skill in the art will understand that the functionality described for each of the devices herein may be implemented via hardware, software or a combination thereof.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
receiving a bandwidth request from a device;
placing the device in a bundle, wherein the bundle includes a plurality of radios to communicate with the device;
receiving a packet addressed to the device; and
transmitting the packet to the device via the plurality of radios.

2. The method of claim 1, wherein the device is a mobile computing device.

3. The method of claim 1, wherein the bandwidth request is received in a management frame sent from the device.

4. The method of claim 3, wherein the management frame includes an identifier of the device.

5. The method of claim 1, wherein the plurality of radios is included in at least one access point.

6. The method of claim 1, wherein the transmitting step further includes:
fragmenting the packet into a plurality of fragments.

7. The method of claim 6, wherein each of the fragments is transmitted simultaneously to the device via the plurality of radios.

8. The method of claim 6, wherein each fragment includes an indication of a location within the packet of the fragment.

9. The method of claim 1, further comprising:
adding an indication of the device to the bundle.

10. The method of claim 1, further comprising:
transmitting an acknowledgment to the device when the device has been placed in the bundle.

11. The method of claim 1, further comprising:
receiving a second bandwidth request from the device; and
removing the device from the bundle based on the second bandwidth request.

12. A device, comprising:
a receiving module to receive a bandwidth request from a device;
a processing module to place the device in a bundle, wherein the bundle includes a plurality of radios to communicate with the device; and
a transmission module to transmit a packet addressed to the device via the plurality of radios.

13. The device of claim 12, wherein the device is a wireless switch.

14. The device of claim 12, wherein the device is a network management arrangement.

15. The device of claim 12, wherein the bandwidth request is received in a management frame sent from the device.

16. The device of claim 12, wherein the plurality of radios is included in at least one access point.

17. The device of claim 12, wherein the transmission module fragments the packet into a plurality of fragments.

18. The device of claim 17, wherein each fragment includes an indication of a location within the packet of the fragment.

19. The device of claim 12, wherein the transmission module transmits an acknowledgment to the device when the device has been placed in the bundle.

20. A system, comprising:
a switch receiving a bandwidth request from a device and placing the device in a bundle, the bundle including a plurality of radios, the switch receiving a packet addressed to the device and fragmenting the packet into a plurality of fragments; and
at least one access point including the plurality of radios, the access point receiving the fragments from the switch and transmitting the fragments to the device using the plurality of radios.

21. A device, comprising:
receiving means for receiving a bandwidth request from a device;
processing means for placing the device in a bundle, wherein the bundle includes a plurality of radios to communicate with the device; and
transmission means for transmitting a packet addressed to the device via the plurality of radios.
